(19) United States
(12) Patent Application Publication
(10) Pub. No.: US 2003/0139955 A1
(43) Pub. Date: Jul. 24, 2003

(54) Task support system and program and method for the same

(75) Inventors: Itaru Kirii, Kawasaki (JP); Kuriko Fujimoto, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/193,327

(22) Filed: Jul. 12, 2002

(30) Foreign Application Priority Data
Jan. 24, 2002 (JP) 2002-15911

(51) Int. Cl. G06F 17/60

(52) U.S. Cl. 705/7

(57) ABSTRACT

The invention provides a task support system that issues a task instruction to an unspecified number of workers, eliminates wasteful work, improves work quality, and monitors the working state of each worker. The task support system which issues a task instruction to workers and monitors the working state of each of the workers, comprises: an instructing means P1 for sending the task instruction to at least one of the workers; a receiving means P2 for receiving from any one of the workers a notification reporting the acceptance or initiation of a task specified by the task instruction; and a canceling means P3 for canceling the task instruction sent to workers other than the worker who reported the acceptance or initiation of the task.

### BACKGROUND OF THE INVENTION

1. Field of the Invention

The present invention relates to a task support system and a program and method for the same and, more particularly, to a task support system that issues a task instruction to an unspecified number of workers, eliminates wasteful work, improves work quality, and monitors the working state of each worker, and a program and method for the same.

2. Description of the Related Art

When there arises a need to issue a task instruction, the usual practice has been that a task instructing person issues the task instruction either by simply specifying a worker or by designating a specific worker by using a worker specifying tool (for example, a system that monitors the schedule of each worker and finds a particular worker who has the time to undertake the task).

Furthermore, the task instruction is issued unilaterally from the task instructing person, and it has not been possible for the worker himself to add a task that he thinks necessary to the task instruction or add information (a memorandum) concerning a specific task to a task item list of the task instruction (task instruction chart). That is, the task instruction issued from the task instructing person and the task instruction that the worker himself thinks necessary, plus information concerning the specific task, are stored at different locations.

Many task instructions do not require designating a specific worker. That is, many tasks can be done by “anyone who has the time.” If such task instructions are given to the workers on the occasion of a meeting such as a morning gathering, the following problems arise on the task instructing person's side: (1) there is no knowing who of the unspecified number of workers will undertake the task; (2) there is no knowing how far the task has progressed, that is, whether the task has been finished or is still being carried out, or whether the task has been initiated at all; and (3) there is no knowing who the instructing person should ask about a problem that occurs when carrying out the task. On the other hand, there arise the following problems on the worker's side: (4) when the worker was preparing to carry out the task, someone else had already undertaken the task; and (5) everybody thought that someone else would undertake the task, but nobody undertook it after all. From the standpoint of the general administrator, the problems are that work efficiency is low and that materials costs and other resources are wasted due to duplication of preparatory work.

Furthermore, if the task instruction issued from the task instructing person and the task instruction that the worker himself thinks necessary, plus information concerning a specific task, are stored at different locations, the worker has to perform the task while checking both of the task instructions, resulting in such problems as inefficient work and increased tendency to overlook important notes on the specific task.

Moreover, task instructions issued to an unspecified number of workers are often unspecific about the start time and end time of the task, and it is difficult to know how much time it takes to finish the task.

### SUMMARY OF THE INVENTION

Accordingly, it is an object of the present invention to provide a task support system that issues a task instruction to an unspecified number of workers, and that can eliminate wasteful work, improve work quality, and monitor the working state of each worker, and a program and method for the same.

It is another object of the present invention to provide a task support system that allows a worker to add any task instruction he thinks appropriate to a task item list so that the list can also be used as a memorandum, and a program and method for the same.

It is a further object of the present invention to provide a task support system that can keep track of the progress of the work assigned to an unspecified number of workers and the time that the work takes, and a program and method for the same.

To achieve the above objects, a task support system according to the present invention, which issues a task instruction to workers and monitors the working state of each of the workers, comprises: instructing means for sending the task instruction to at least one of the workers; receiving means for receiving from any one of the workers a notification reporting the acceptance or initiation of a task specified by the task instruction; and canceling means for canceling the task instruction sent to other workers than the worker who reported the acceptance or initiation of the task.

The task support system is characterized by the inclusion of alarm means for generating an alarm if a notification reporting the acceptance or initiation of the task specified by the task instruction is not received within a predetermined time after sending the task instruction.

The task support system is also characterized in that the task instruction includes a memorandum added by any one of the workers for a specific task as detailed information relating to the task specified by the task instruction.

To achieve the above objects, the present invention also provides, in a task support system which issues a task instruction to workers and monitors the working state of each of the workers, a program for causing a computer to implement: instructing means for sending the task instruction to at least one of the workers; receiving means for receiving from any one of the workers a notification reporting the acceptance or initiation of a task specified by the task instruction; and canceling means for canceling the task instruction sent to workers other than the worker who reported the acceptance or initiation of the task.

To achieve the above objects, the present invention also provides a task support method which issues a task instruction to workers and monitors the working state of each of the workers, comprising: an instructing step for sending the task instruction to at least one of the workers; a receiving step for receiving from any one of the workers a notification reporting the acceptance or initiation of a task specified by the task instruction; and a canceling step for canceling the task instruction sent to other workers than the worker who reported the acceptance or initiation of the task.

### BRIEF DESCRIPTION OF THE DRAWINGS

FIG. 1 is a diagram showing an application example of a task support system according to the present invention;

FIG. 2 is a flowchart illustrating a processing procedure for a task support method according to the present invention;

FIG. 3 is a flowchart illustrating the operation of a monitor and terminals in the task support system shown in FIG. 1;

FIG. 4 is a diagram showing a terminal display screen which changes as the flow of FIG. 3 progresses;

FIG. 5 is a diagram showing a monitor display screen which changes as the flow of FIG. 3 progresses;

FIG. 6 is a flowchart illustrating a process for monitoring the progress of work after a task instruction has been issued;

FIG. 7 is a flowchart illustrating a process for monitoring the progress of work after a task start time notification has been received;

FIGS. 8(A) and 8(B) are diagrams for explaining the method of installing, on a monitor or a terminal, a program and its recording medium used in the task support system of the present invention: FIG. 8(A) is a diagram showing the detailed configuration of the monitor, and FIG. 8(B) is a diagram showing the internal configuration of the main unit of the monitor.

### DESCRIPTION OF THE PREFERRED EMBODIMENTS

The present invention will be described in detail below with reference to the accompanying drawings.

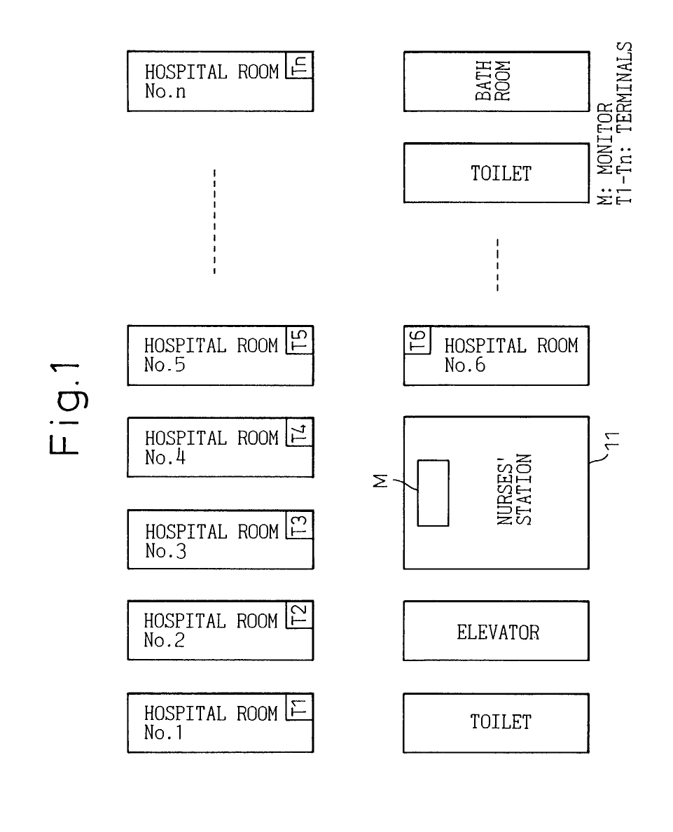

FIG. 1 is a diagram showing an application example of a task support system according to the present invention. In FIG. 1, reference character M designates a monitor, and T1 to Tn represent terminals. The task support system shown in FIG. 1 supports the work of nurses working in a hospital, in which the task administrator is the director of the hospital, the task instructing person is the head nurse, and the workers are the nurses (registered nurses, licensed practical nurses, and trainees). The monitor M is installed in a nurses' station 11, while the terminals T1 to Tn are installed in hospital rooms No. 1 to No. n, respectively; the monitor M and the terminals T1 to Tn are interconnected via a LAN or wireless link so that they can communicate with each other.

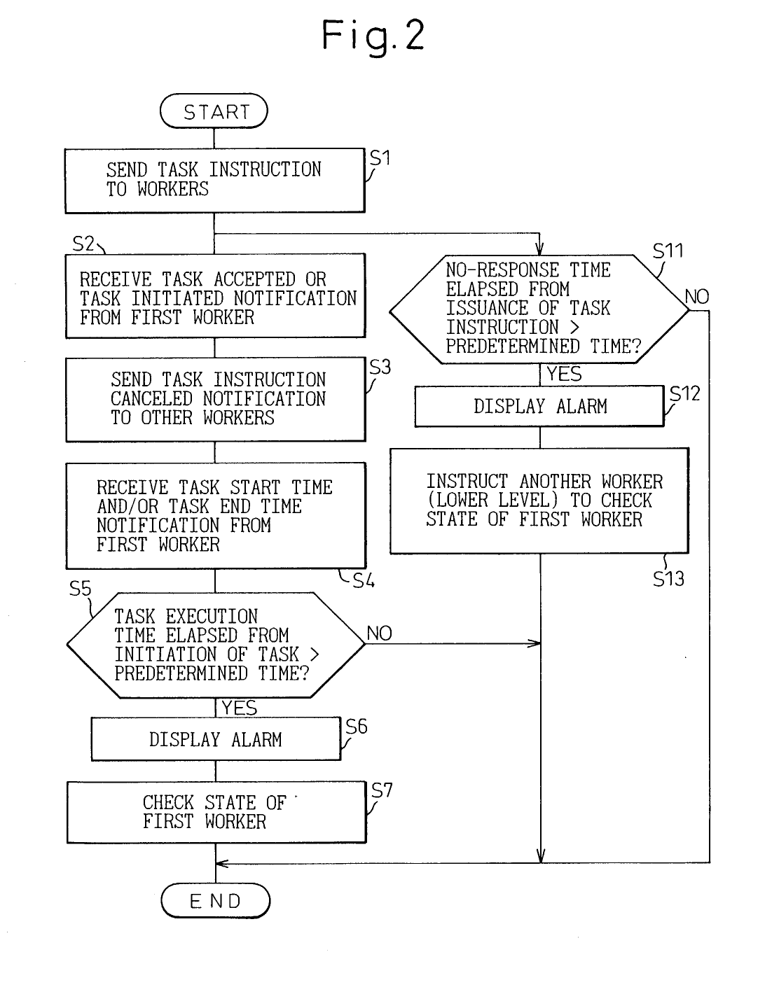

FIG. 2 is a flowchart illustrating a processing procedure for a task support method according to the present invention. In FIG. 2, the number that follows S indicates the step number. In the task support method of the present invention, the task support system issues a task instruction to workers, and monitors the working state of each of the worker. First, in step S1, the task instructing person sends the task instruction to at least one worker (the instruction is sent from the monitor M to the terminals T1 to Tn). Then, in step S2, one of the workers (the first worker) notifies the task instructing person (from corresponding one of the terminals Tl to Tn to the monitor M) that she accepts or initiates the task specified by the task instruction. Next, in step S3, the task instructing person sends a task instruction canceled notification to other workers (second workers) than the worker who responded with the task accepted or initiated notification, especially to those workers who have not undertaken the task instruction (the notification is sent from the monitor M to the corresponding terminals T1 to Tn).

In step S11, the monitor M counts the time elapsed from the time that the task instruction is issued, until the task is actually initiated (no-response time elapsed from the issuance of the task instruction), and determines whether or not the no-response time elapsed from the issuance of the task instruction is longer than a predetermined time, to determine whether a notification reporting the acceptance or initiation of the task specified by the task instruction is received from any one of the workers within the predetermined time. If the result of the determination is YES, it is determined that the elapsed no-response time is too long, and the process proceeds to step S12; on the other hand, if the result is NO, it is determined that the situation is normal, and the routine is terminated. In step S12, the monitor M displays an alarm on the display screen, and the process proceeds to step S13 where an instruction is sent to another worker (whose work ability level is lower) (from the monitor M to a terminal Tj) to instruct her to check the state of the worker to whom the task instruction was sent. Here, the work ability levels are classified into high, middle, and low levels in the order of a registered nurse, a practical nurse, and a trainee; depending on the type of the task, ability higher than a certain level is required. For example, tasks requiring the high level ability include giving a patient an injection, a drip infusion, etc., middle level tasks include measuring body temperature, blood pressure, etc., and low level tasks include wiping a patient's body, etc.

When the first worker notifies the task instructing person in step S2 that she has initiated the task specified by the task instruction, the task start time is transmitted in step S2 from the terminal Tj of the first worker to the monitor M, while when the first worker only notifies the task instructing person in step S2 that she accepts the task, the task start time is transmitted from the terminal Tj of the first worker to the monitor M in step S4. When the task undertaken by the first worker is completed, the task end time is transmitted from the terminal Tj of the first worker to the monitor M in step S4.

In step S5, the time elapsing from the time that the task initiated notification is received from the first worker for the task specified by the task instruction is counted while the task is being executed (task execution time elapsed from the initiation of the task), and determines whether or not the task execution time elapsed from the initiation of the task is longer than a predetermined time, to determine whether the task is progressing as scheduled; if the result of the determination is YES, it is determined that the elapsed task execution time is too long, but if the result is NO, it is determined that the task is progressing normally, and the routine is terminated. In step S6, the monitor displays an alarm on the display screen. In step S7, the task instructing person checks the state of the first worker.

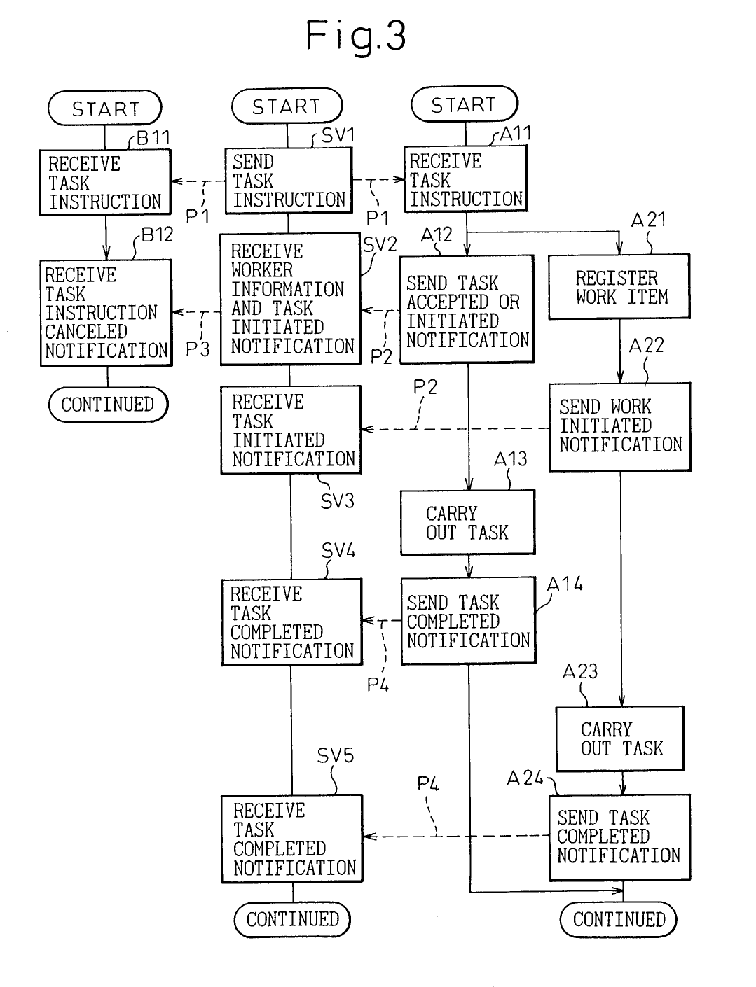

FIG. 3 is a flowchart illustrating the operation of the monitor and terminals in the task support system shown in FIG. 1. Shown in the center is the flow of processing steps SV1 to SV3 performed at the monitor which is monitored by the task instructing person, and at the right is shown the flow of processing steps A11 to A14 (for task name “a”) and A21 to A24 (for task name “b”) performed at the terminal of the worker A, while at the left is shown the flow of processing steps B11 and B12 performed at the terminals of the workers B and C. In FIG. 3, dashed line P1 is an instructing means for sending a task instruction to at least one worker, dashed line P2 is a responding means (a receiving means when viewed from the monitor side) by which one of the workers sends a notification reporting the acceptance or initiation of the task specified by the task instruction, and dashed line P3 is a canceling means for canceling the task instruction sent to workers other than the worker who responded with the task accepted or initiated notification.

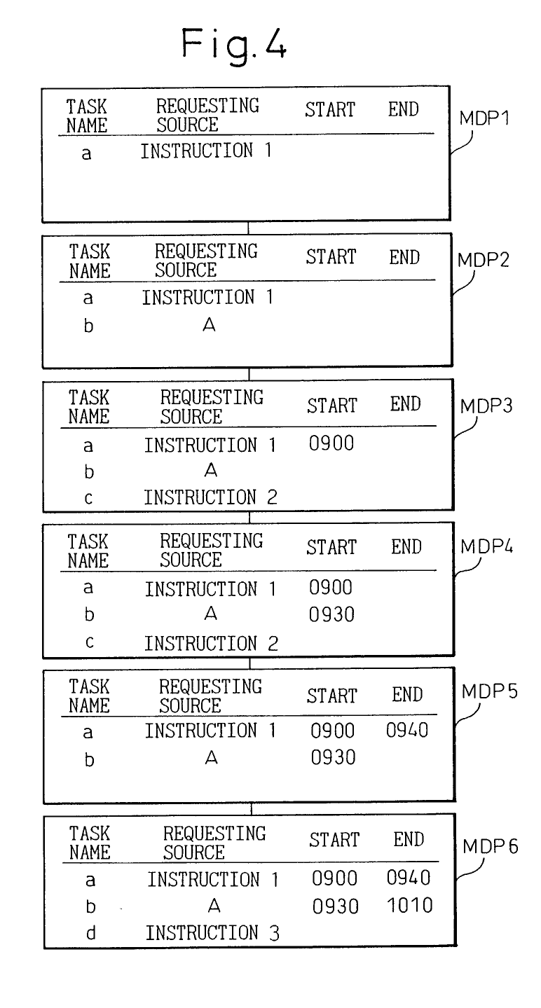

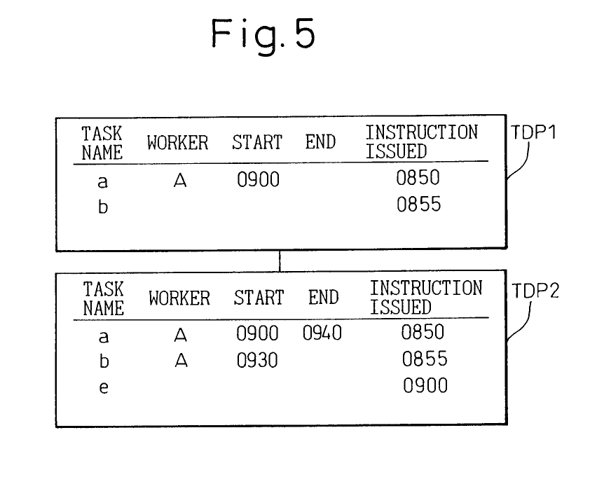

FIG. 4 is a diagram showing a terminal display screen which changes as the flow of FIG. 3 progresses, and FIG. 5 is a diagram showing a monitor display screen which changes as the flow of FIG. 3 progresses. The operation of the monitor and terminals will be described below by referring to FIGS. 3 to 5 back and forth.

First, in step SV1, a task instruction with task name “a” is sent from the monitor of the task instructing person to the respective terminals of the workers A, B, and C, and in steps A11 and B11, the terminals of the workers A, B, and C receive the instruction. At each of the terminals of the workers A, B, and C, a task item list (FIG. 4) is displayed on the screen MDP1, from which the respective workers recognize that the task name “a” has been specified.

In step A21, the worker A enters a task item and task name “b” created by herself into the task item list. The screen MDP2 (FIG. 4) is displayed at the terminal of each worker, and the respective workers recognize that the task name “b” has been specified.

If a special note on a specific task or a specific patient is entered in the form of a memorandum into the task item list, such a note can be used by the worker that entered it and can also be shared with other workers, and serves as useful means to improve the work.

In step A12, the worker A sends a notification from her terminal to the monitor to indicate that she accepts (undertakes) or initiates the task specified by the task name “a”. The screen MDP3 (FIG. 4) is displayed on the terminal of the worker A. The screen MDP3 also shows that a task instruction with task name “c”, issued from another task instructing person 2, has been added.

In step SV2, the monitor of the task instructing person receives the task accepted or initiated notification for task name “a” from the worker A. The screen TDP1 (FIG. 5) is displayed at the monitor, from which the task instructing person recognizes that the worker A has initiated the task with task name “a”, and sends a task instruction canceled notification for task name “a” from the monitor to the terminals of the workers B and C.

In step B12, the terminals of the workers B and C receive the task instruction canceled notification for task name “a” from the monitor.

In step A22, the worker A sends a task initiated notification for task name “b” from her terminal to the monitor. The screen MDP4 (FIG. 4) is displayed at the terminal of the worker A, indicating that the task with task name “b” has been initiated.

In step SV3, the monitor of the task instructing person receives the task initiated notification for task name “b” from the terminal of the worker A.

In step A13, the worker A carries out the task with task name “a”.

In step A14, the worker A sends a task completed notification for task name “a” from her terminal to the monitor of the task instructing person (the means P4 indicated by dashed line: a receiving means when viewed from the monitor side). The screen MDP5 (FIG. 4) is displayed at the terminal of the worker A, indicating that the task with task name “a” has been completed. On the other hand, the screen TDP2 (FIG. 5) shows that the task instruction with task name “c”, issued from another task instructing person, has been canceled.

In step SV4, the monitor of the task instructing person receives the task completed notification for task name “a” from the terminal of the worker A. The screen TDP2 (FIG. 5) is displayed at the monitor, from which the task instructing person recognizes that the task with task name “a” has been completed by the worker A. The screen MDP5 (FIG. 4) also shows that a new task instruction with task name “e” has been added.

In step A23, the worker A carries out the task with task name “b”.

In step A24, the worker A sends a task completed notification for task name “b” from her terminal to the monitor of the task instructing person (the means P4 indicated by dashed line: a receiving means when viewed from the monitor side). The screen MDP6 (FIG. 4) is displayed at the terminal of the worker A, indicating that the task with task name “b” has been completed. The screen MDP6 also shows that a task instruction with task name “d”, issued from another task instructing person 3, has been added.

In step SV5, the monitor of the task instructing person receives the task completed notification for task name “b” from the terminal of the worker A.

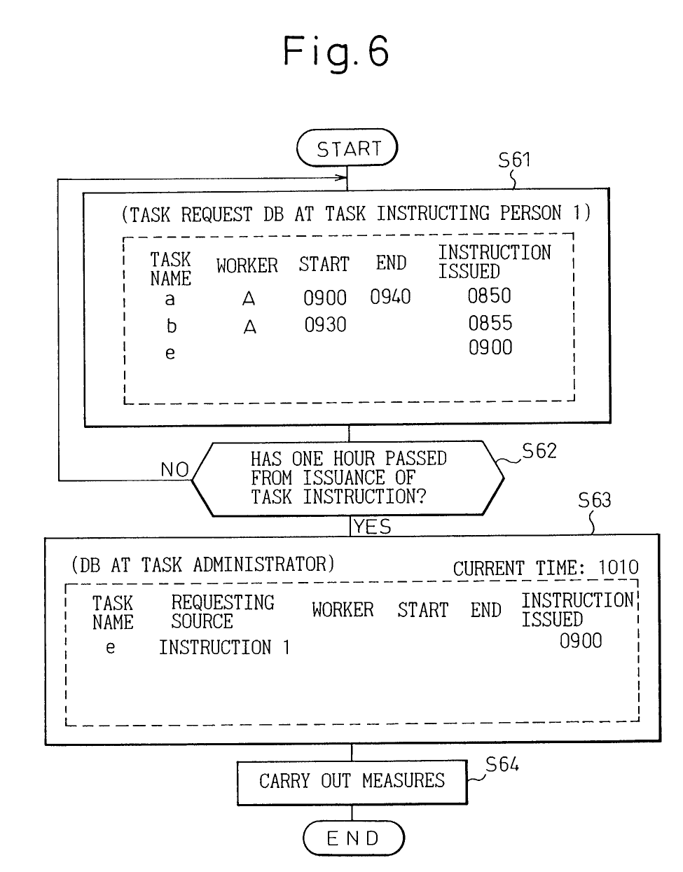

FIG. 6 is a flowchart illustrating a process for monitoring the progress of work after a task instruction has been issued. In step S61, as can be seen from the task item list shown on the monitor screen, the task instructing person issues a task instruction with task name “e” to each worker at 09:00 (the instruction is sent from the monitor to the terminal of each worker).

In step S62, the time elapsing from the time that the task instruction is issued to each worker (no-response time elapsed from the issuance of the task instruction) until the task is actually initiated is counted, and it is determines whether or not the no-response time elapsed from the issuance of the task instruction is longer than a predetermined time (1 hour); if the result of the determination is YES, it is determined that the elapsed no-response time is too long, and the process proceeds to step S63, but if the result is NO, it is determined that the situation is normal, and the process returns to step S61.

In step S63, as can be seen from the task item list shown on the monitor screen, the task with task name “e” is not yet started at 10:10; therefore, the monitor M displays an alarm on its display screen, and the process proceeds to step S64 where an instruction is sent to another worker (whose work ability level is lower) (from the monitor M to the terminal Tj) to instruct her to check the state of the worker to whom the task instruction was sent. From the task item list shown on the monitor screen, it can be seen that at 10:10, the task with task name “a” and the task with task name “b” are already completed.

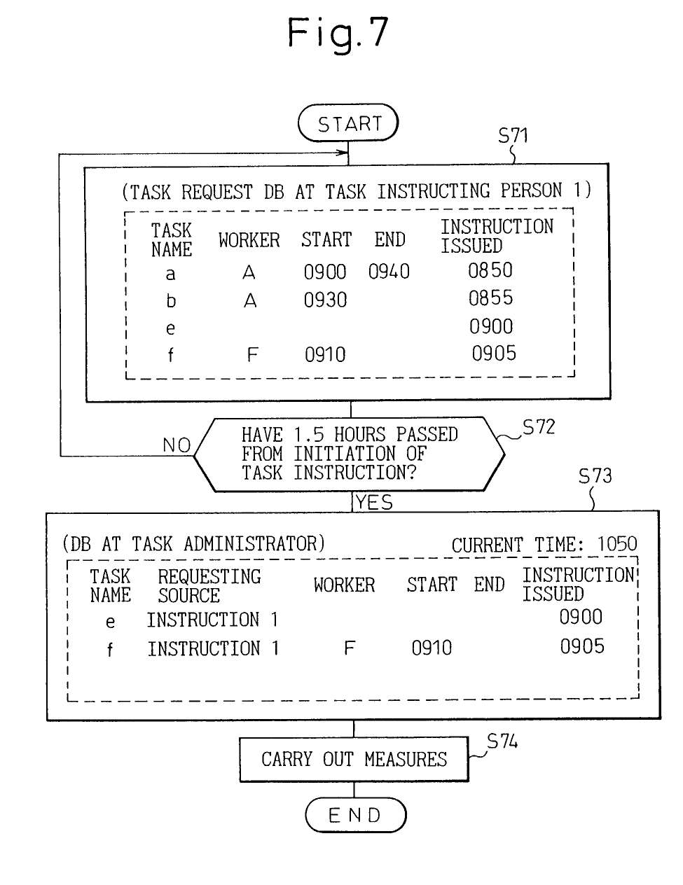

FIG. 7 is a flowchart illustrating a process for monitoring the progress of work after a task start time notification has been received. In step S71, from the task item list shown on the monitor screen, it can be seen that a notification reporting that the task with task name “b” was initiated at 9:30 by the worker A was sent from the terminal of the worker A to the monitor, that a notification reporting that the task with task name “f” was initiated at 9:10 by the worker F was sent from the terminal of the worker F to the monitor, and that a notification reporting that the task with task name “a” was completed at 9:40 by the worker A was sent from the terminal of the worker A to the monitor.

In step S72, the time elapsing from the time that the task initiated notification is received from the worker A for the task specified by the task instruction is counted while the task is being executed (task execution time elapsed from the initiation of the task), and it is determined whether or not the task execution time elapsed from the initiation of the task is longer than a predetermined time (1.5 hours), to determine whether the task specified by the task instruction is progressing as scheduled; if the result of the determination is YES, it is determined that the elapsed task execution time is too long, and the process proceeds to step S73, but if the result is NO, it is determined that the task is progressing normally, and the process returns to step S71. In step S73, as can be seen from the task item list shown on the monitor, the task with task name “f” initiated at 9:10 has not been completed at 10:50; therefore, the monitor M displays an alarm on its display screen, and the process proceeds to step S74 where the task instructing person checks the state of the worker A. From the task item list shown on the monitor screen, it can be seen that at 10:50, the task with task name “a” and the task with task name “b” are already completed.

The above task support system offers the following advantages.

(1) As every task instruction is given to each individual worker, each worker can recognize the task assigned to her.

(2) Once a worker accepts (undertakes) a task instruction or initiates the specified task, the task instruction sent to other workers than that worker is canceled, avoiding needless duplication of work among the workers, and thus, the general administrator can eliminate wastage of resources due to duplication of preparatory work.

(3) As the task instructing person is notified of who will undertake the specified task, the instructing person will not have to worry about who will undertake the job, and can issue an additional task instruction or inquire about the progress of the task or a problem, if any.

(4) As every task instruction is issued by classifying it according to the ability level of the worker, a worker need not accept a task instruction that does not match her ability level. On the other hand, the task instructing person will not worry about whether or not a person who can fulfill the task will undertake the job.

(5) As every worker can enter a task item she created and a special note on a specific patient into the task list, the worker can have a memorandum for her own work.

(6) As the task start time and the task end time are reported from the worker, the task instructing person can rest assured because she need not worry about “who will undertake the task and when” and “whether the task is completed and, if completed, when.” Further, if the task is taking too long, the task instructing person can issue an additional instruction or can take measures by examining the state of the task.

The above embodiment has been described by taking as an example the case of supporting the work of nurses in a hospital, but it will be appreciated that the present invention can also be applied to the support of other types of work, for example, work at a film production site.

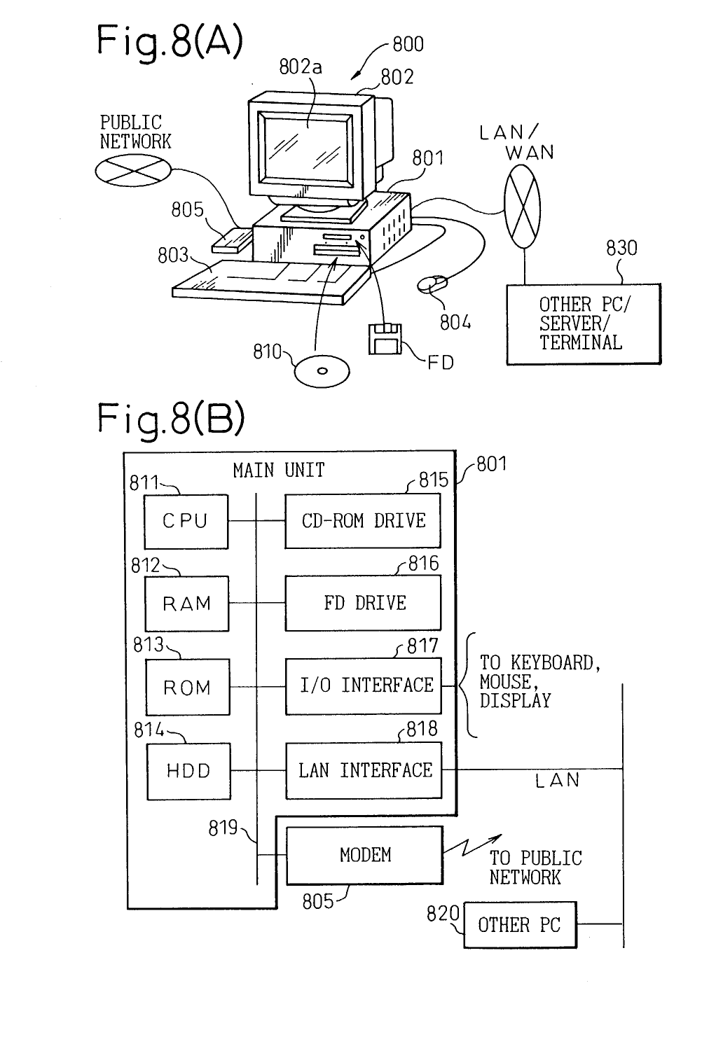

FIGS. 8(A) and 8(B) are diagrams for explaining the method of installing, on a monitor or a terminal, a program and its recording medium used in the task support system of the present invention: FIG. 8(A) is a diagram showing the detailed configuration of the monitor, and FIG. 8(B) is a diagram showing the internal configuration of the main unit of the monitor.

The monitor (hereinafter referred to as the computer system) 800 shown in FIG. 8(A) comprises the main unit 801, a display 802 for displaying images and other information on a display screen 802a in accordance with an instruction from the main unit 801, a keyboard 803 used to enter various kinds of information into the computer system 800, a mouse 804 for pointing to a desired position on the display screen 802a of the display 802, and a modem 805 connected to a public network.

As shown in FIG. 8(B), the main unit 801 contains such components as a CPU 811, a RAM 812, a ROM 813, disk drive units (HDD 814, CD-ROM drive 815, and FDD 816), an I/O interface 817 connected to the display 802, keyboard 803, mouse 804, etc., and a LAN interface 818 for accessing a data base connected via a communication line, and these components are interconnected via a bus 819.

The program of the present invention is stored on a CD-ROM 810a, a floppy disk (FD) 810b, or other removable recording medium such as a DVD disk, magneto-optical disk, or IC card not shown, or stored in a data base connected via the communication line and accessible via the modem 805 or the LAN interface 818, and the program is installed on the computer system 800 and executed on the computer system 800. The thus installed program of the invention is stored on a hard disk (HD) in the HDD unit 814, and executed by the CPU 811 using the RAM 812, etc.

The specific configuration of the terminal not shown consists mainly of a main unit (not shown), a display unit (not shown), and an operation key (not shown). The internal configuration of the main unit of the terminal is similar to that of the main unit 801 shown in FIG. 8(B); that is, the main unit comprises such components as a CPU 811, a RAM 812, a ROM 813, an I/O interface 817 connected to the display unit (not shown), operation key (not shown), etc., and a LAN interface 818 for accessing a data base connected via the communication line, and these components are interconnected via a bus 819.

The program recording medium of the present invention includes not only a removable medium such as the CD-ROM 810a, floppy disk (FD) 810b, DVD disk, magneto-optical disk, or IC card, or a storage device such as a hard disk internal or external to the computer system 800, but also a data base connected via a communication line and holding therein the program of the invention to be installed such as, for example, a data base in another computer system (PC) or server indicated at 820 and connected to the computer system 800 via the LAN, and even includes a transmission medium on the communication line. The computer system 800 can be connected to another computer system (PC), server, or terminal indicated at 820 via the LAN/WAN.

The program necessary for the terminal is installed from the monitor 800 via the LAN/WAN.

As described above, according to the task support system of the invention and the program and method for the same, a task instruction is issued to an unspecified number of workers, and work quality can be improved by eliminating wasteful work.

According to the present invention, each worker is allowed to create a task instruction and add it to a task item list so that the task item list can also be used as a memorandum for a specific task.

Furthermore, according to the present invention, it becomes possible to keep track of the times related to the progress of the task specified by the task instruction issued to an unspecified number of workers.

What is claimed is:

1. A task support system which issues a task instruction to workers and monitors the working state of each of said workers, comprising:
instructing means for sending said task instruction to at least one of said workers;
receiving means for receiving from any one of said workers a notification reporting the acceptance or initiation of a task specified by said task instruction; and
canceling means for canceling said task instruction sent to workers other than said worker who reported the acceptance or initiation of said task.

2. A task support system as claimed in claim 1, further comprising alarm means for generating an alarm if a notification reporting the acceptance or initiation of the task specified by said task instruction is not received within a predetermined time after sending said task instruction.

3. A task support system as claimed in claim 1 or 2, further comprising alarm means for generating an alarm if a notification reporting the completion of the task specified by said task instruction is not received within a predetermined time after receiving said notification reporting the acceptance or initiation of said task specified by said task instruction.

4. A task support system as claimed in claim 2 or 3, wherein said alarm means sends an instruction to another worker to whom said task instruction was not sent, instructing said other worker to check the working state of the worker to whom said task instruction was sent.

5. A task support system as claimed in claim 4, wherein said other worker to whom said task instruction was not sent is lower in work ability than said worker to whom said task instruction was sent.

6. A task support system as claimed in any one of claims 1 to 5, wherein said task instruction includes information indicating the level of the task specified by said task instruction.

7. A task support system as claimed in any one of claims 1 to 6, wherein said task instruction includes a memorandum added by any one of said workers for a specific task as detailed information relating to the task specified by said task instruction.

8. A task support system as claimed in any one of claims 1 to 7, wherein said task instruction is displayed in the form of a task item list which includes task name, requesting person and/or worker, start time, end time, and instruction issue time.

9. A task support system as claimed in claim 8, wherein said task instruction can also be registered by said worker in said task item list.

10. A task support system as claimed in claim 9, wherein when the start time and/or end time of the task carried out by said worker are received, the respective times are automatically registered, and at the same time, are reported to said task instructing person and/or said worker.

11. In a task support system which issues a task instruction to workers and monitors the working state of each of said workers, a program for causing a computer to implement:
instructing means for sending said task instruction to at least one of said workers;
receiving means for receiving from any one of said workers a notification reporting the acceptance or initiation of a task specified by said task instruction; and
canceling means for canceling said task instruction sent to other workers than said worker who reported the acceptance or initiation of said task.

12. A task support method which issues a task instruction to workers and monitors the working state of each of said workers, comprising:
an instructing step for sending said task instruction to at least one of said workers;
a receiving step for receiving from any one of said workers a notification reporting the acceptance or initiation of a task specified by said task instruction; and
a canceling step for canceling said task instruction sent to workers other than said worker who reported the acceptance or initiation of said task.
